(19) United States
(12) Patent Application Publication
(10) Pub. No.: US 2025/0182938 A1
(43) Pub. Date: Jun. 5, 2025

(54) ELECTRONIC COMPONENT

(71) Applicant: TDK Corporation, Tokyo (JP)

(72) Inventors: Kohei ARAI, Tokyo (JP); Yoshihiko SATOH, Tokyo (JP); Atsunori SUZUKI, Tokyo (JP); Takeshi OYANAGI, Tokyo (JP)

(73) Assignee: TDK Corporation, Tokyo (JP)

(21) Appl. No.: 18/783,821

(22) Filed: Jul. 25, 2024

(30) Foreign Application Priority Data
Nov. 30, 2023 (JP) 2023-202669

(51) Int. Cl. H01C 7/102; H01C 7/112

(52) U.S. Cl. CPC H01C 7/102; H01C 7/112

(57) ABSTRACT

An electronic component includes a ceramic body and a sintered metal layer disposed on the ceramic body. The sintered metal layer includes a first region including a plurality of first crystal grains including a first metal, a second region in contact with the first region and including a plurality of second crystal grains including a second metal different from the first metal, and a third region in contact with the second region and including glass. The sintered metal layer has an existence ratio of the first region and the second region that is larger than 1, the existence ratio being expressed by an area ratio of the first region to the second region.

### CROSS-REFERENCE TO RELATED APPLICATIONS

This application is based upon and claims the benefit of priority from Japanese Patent Application No. 2023-202669, filed on Nov. 30, 2023. The entire contents of which are incorporated herein by reference.

### BACKGROUND

### Field

The present disclosure relates to an electronic component.

### Description of the Related Art

Known electronic components include a ceramic body and a sintered metal layer disposed on the ceramic body (for example, refer to Japanese Unexamined Patent Publication No. 2008-60612). An external electrode includes Ag.

### SUMMARY

In the electronic component, characteristics may be deteriorated due to moisture entry.

The electronic component may include a plating layer outside the sintered metal layer. The plating layer is formed through, for example, a wet plating. When a plating solution used in the wet plating reaches the ceramic body, the characteristics of the electronic component may be deteriorated. Not only the plating solution but also moisture existing in an external environment of the electronic component may infiltrate into the electronic component.

One aspect of the present disclosure provides an electronic component that reduces characteristic deterioration.

An electronic component according to one aspect of the present disclosure includes a ceramic body and a sintered metal layer disposed on the ceramic body. The sintered metal layer includes a first region including a plurality of first crystal grains including a first metal, a second region in contact with the first region and including a plurality of second crystal grains including a second metal different from the first metal, and a third region in contact with the second region and including glass. The sintered metal layer has an existence ratio of the first region and the second region that is larger than 1, the existence ratio being expressed by an area ratio of the first region to the second region.

In the one aspect, the sintered metal layer has an existence ratio of the first region and the second region that is larger than 1, the existence ratio being expressed by an area ratio of the first region to the second region. The plurality of second crystal grains included in the second region tend to be in contact with the plurality of first crystal grains included in the first region having a larger area ratio than the second region. The plurality of second crystal grains bring reduced contact between the plurality of first crystal grains. The glass included in the third region can be in contact with the second region, and can exist between the plurality of first crystal grains having the reduced contact. The sintered metal layer is densified. Therefore, the one aspect reduces characteristic deterioration of the electronic component.

In the one aspect, the area ratio of the first region to the second region may be larger than 1, in a cross section of the sintered metal layer.

In a configuration in which the area ratio of the first region to the second region is larger than 1, in the cross section of the sintered metal layer, the plurality of second crystal grains further tend to be in contact with the plurality of first crystal grains in the cross section, and further reduce the contact between the plurality of first crystal grains. The glass included in the third region contacts the second region, and can further exist between the plurality of first crystal grains having reduced contact with each other. The sintered metal layer is densified. Therefore, this configuration reliably reduces the characteristic deterioration of the electronic component.

In the one aspect, the plurality of first crystal grains may have a grain size larger than the grain size of the plurality of second crystal grains in the cross section.

In a configuration in which the plurality of first crystal grains has the grain size larger than the grain size of the plurality of second crystal grains in the cross section of the sintered metal layer, the plurality of second crystal grains tends to be positioned between the plurality of first crystal grains in the cross section, and still further reduce the contact between the plurality of first crystal grains. The glass included in the third region contacts the second region, and can still further exist between the plurality of first crystal grains having reduced contact with each other. The sintered metal layer is further densified. Therefore, this configuration further reliably reduces the characteristic deterioration of the electronic component.

In the one aspect, the area ratio of the first region to the second region may be larger than 1, in a surface of the sintered metal layer.

In a configuration in which the area ratio of the first region to the second region is larger than 1, in the surface of the sintered metal layer, the plurality of second crystal grains further tends to be in contact with the plurality of first crystal grains in the surface, and further reduce the contact between the plurality of first crystal grains. The glass included in the third region contacts the second region, and can further exist between the plurality of first crystal grains having reduced contact with each other. The sintered metal layer is further densified. Therefore, this configuration reliably reduces the characteristic deterioration of the electronic component.

In the one aspect, the plurality of first crystal grains may have a grain size larger than a grain size of the plurality of second crystal grains in the surface of the sintered metal layer.

In a configuration in which the plurality of first crystal grains has a grain size larger than the grain size of the plurality of second crystal grains in the surface of the sintered metal layer, the plurality of second crystal grains tends to be positioned between the plurality of first crystal grains in the surface, and still further reduce the contact between the plurality of first crystal grains. The glass included in the third region contacts the second region, and can still further exist between the plurality of first crystal grains having reduced contact with each other. The sintered metal layer is further densified. Therefore, this configuration further reliably reduces the characteristic deterioration of the electronic component.

In the one aspect, the sintered metal layer may be formed with a void to which the second region is exposed.

A configuration in which the void is formed in the sintered metal layer decreases stress acting on the sintered metal layer and decreases occurrence of cracks in the ceramic body. Therefore, this configuration further reliably reduces, for example, the characteristic deterioration of the electronic component.

In the one aspect, the sintered metal layer includes a grain boundary between the first crystal grains and the second crystal grains, the grain boundary including a region that does not include an alloy of the first metal and the second metal.

In the region where the grain boundary includes a region that does not include an alloy of the first metal and the second metal, the first metal and the second metal exist independently of each other. In a configuration including the region where the alloy of the first metal and the second metal does not exist, the plurality of second crystal grains tend to be positioned between the plurality of first crystal grains, and still further reduce the contact between the plurality of first crystal grains. The glass included in the third region contacts the second region, and can yet still further exist between the plurality of first crystal grains having reduced contact with each other. The sintered metal layer is still further densified. Therefore, this configuration still further reliably reduces the characteristic deterioration of the electronic component.

In the one aspect, the second metal may have a melting point higher than a melting point of the first metal.

In a configuration in which the second metal has a melting point higher than the melting point of the first metal, the second metal further tends to maintain a solid state than the first metal. The plurality of second crystal grains still further reduce the contact between the plurality of first crystal grains. The glass included in the third region contacts the second region, and can yet still further exist between the plurality of first crystal grains having reduced contact with each other. The sintered metal layer is still further densified. Therefore, this configuration still further reliably reduces the characteristic deterioration of the electronic component.

In the one aspect, the second metal may have an ionization tendency larger than an ionization tendency of the first metal.

In a configuration in which the second metal has an ionization tendency larger than the ionization tendency of the first metal, the second metal further tends to form an oxide than the first metal. The second metal is not alloyed with the first metal. The plurality of second crystal grains still further reduce the contact between the plurality of first crystal grains. The glass included in the third region contacts the second region, and can yet still further exist between the plurality of first crystal grains having reduced contact with each other. The sintered metal layer is still further densified. Therefore, this configuration still further reliably reduces the characteristic deterioration of the electronic component.

In the one aspect, the ceramic body may include a semiconductor ceramic material.

The present disclosure will become more fully understood from the detailed description given hereinafter and the accompanying drawings which are given by way of illustration only, and thus are not to be considered as limiting the present disclosure.

Further scope of applicability of the present disclosure will become apparent from the detailed description given hereinafter. However, it should be understood that the detailed description and specific examples, while indicating examples of the disclosure, are given by way of illustration only, since various changes and modifications within the spirit and scope of the disclosure will become apparent to those skilled in the art from this detailed description.

### BRIEF DESCRIPTION OF THE DRAWINGS

FIG. 1 is a perspective view illustrating an electronic component according to an example;

FIG. 2 is a diagram illustrating a cross-sectional configuration of the electronic component according to the example;

FIG. 3 is a diagram illustrating a cross-sectional configuration of the electronic component according to the example;

FIG. 4 is a diagram illustrating a configuration of a cross section of a sintered metal layer;

FIG. 5 is a diagram illustrating the configuration of the cross section of the sintered metal layer;

FIG. 6 is a diagram illustrating a configuration of a surface of a sintered metal layer; and

FIG. 7 is a diagram illustrating the configuration of the surface of a sintered metal layer.

### DETAILED DESCRIPTION

Hereinafter, examples of the present disclosure will be described in detail with reference to the accompanying drawings. In the following description, the same elements or elements having the same functions are denoted with the same reference numerals and overlapped explanation is omitted.

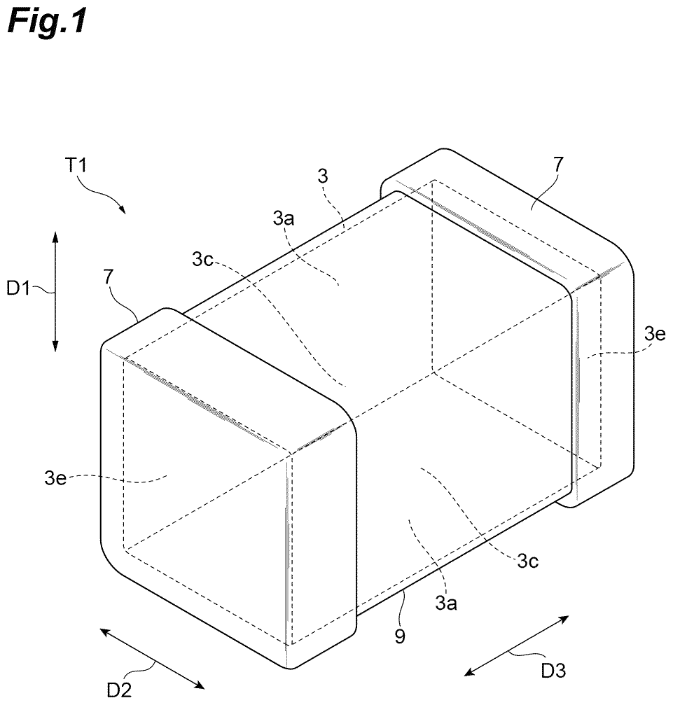

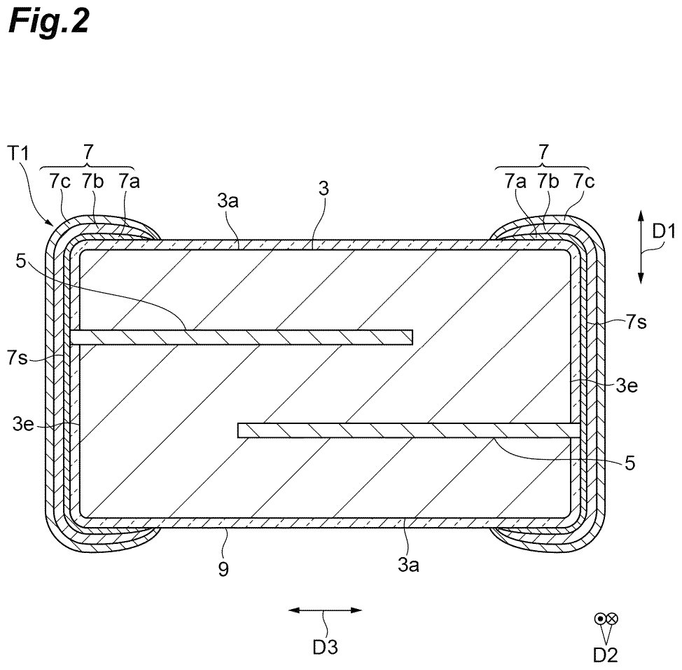

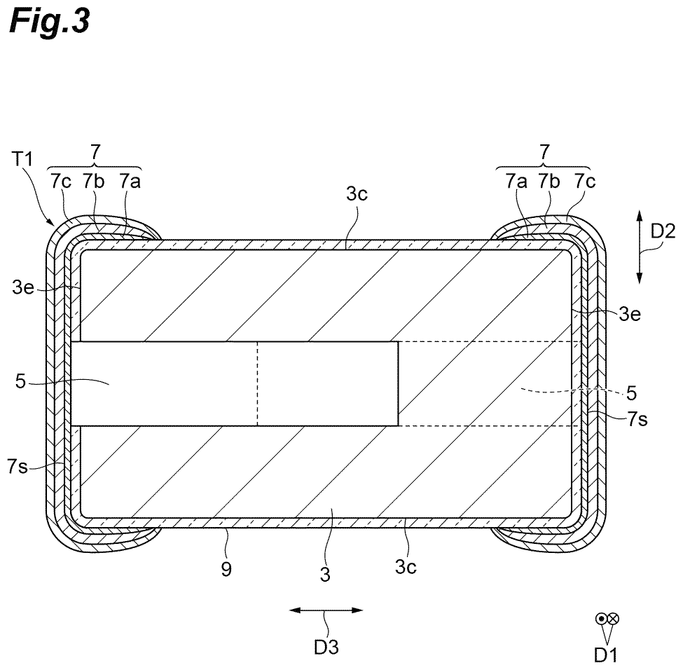

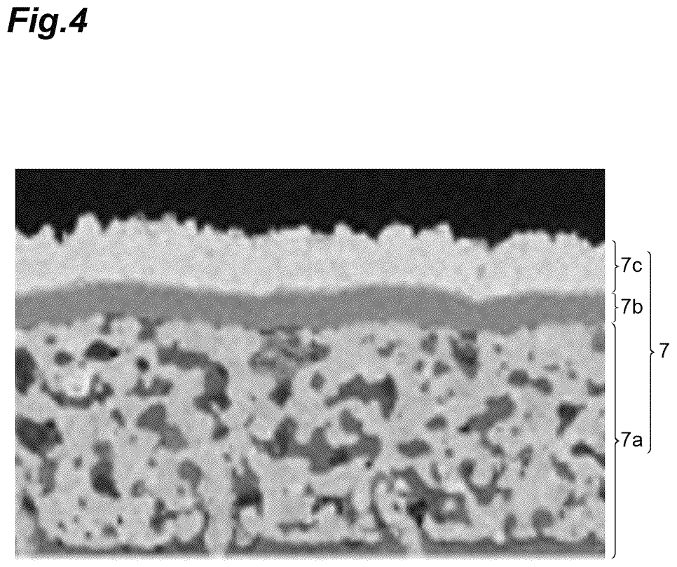

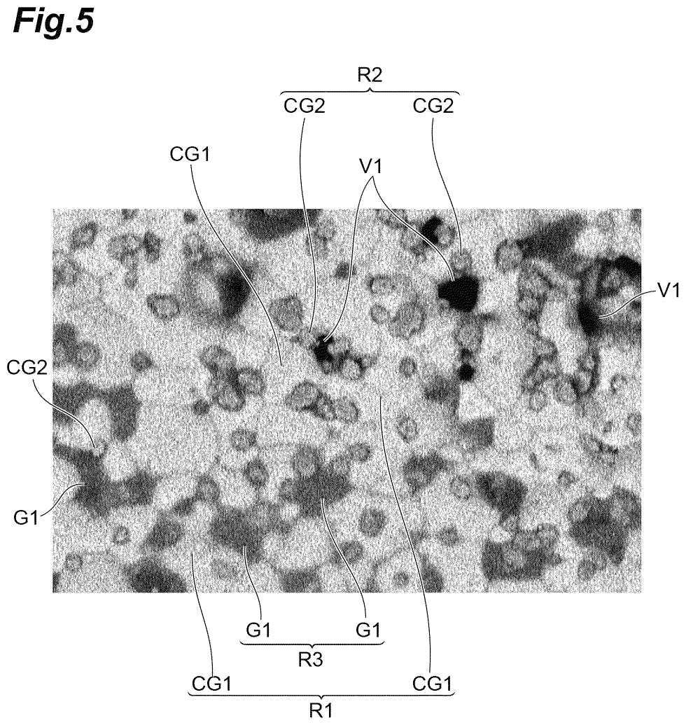

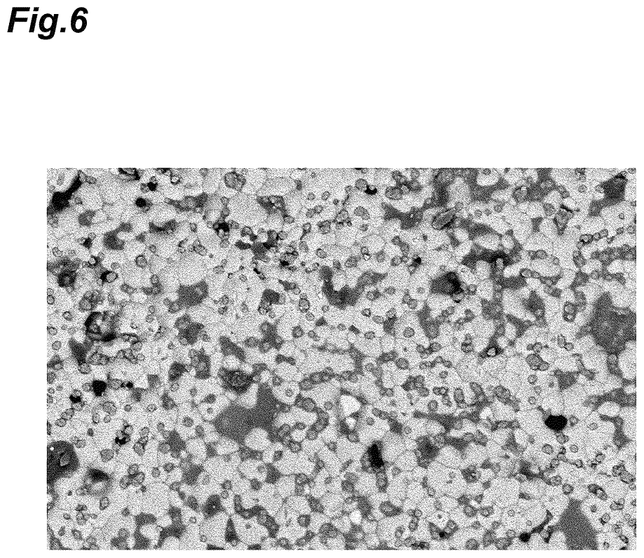

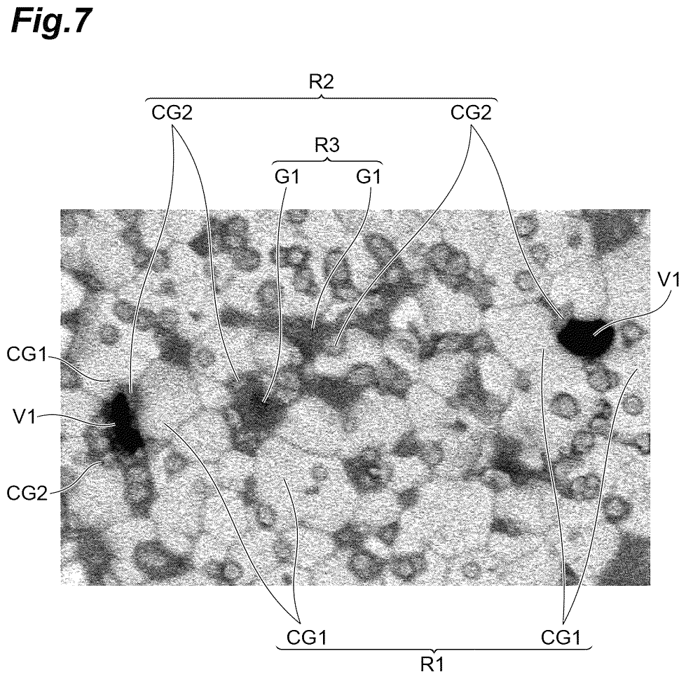

A configuration of a chip varistor T1 according to the example will be described with reference to FIGS. 1 to 7. FIG. 1 is a perspective view illustrating the chip varistor according to the example. FIGS. 2 and 3 are diagrams illustrating a cross-sectional configuration of the chip varistor according to the example. FIGS. 4 and 5 are diagrams illustrating a configuration of a cross section of a sintered metal layer. FIGS. 6 and 7 are diagrams illustrating a configuration of a surface of the sintered metal layer. An electronic component includes, for example, the chip varistor T1.

As illustrated in FIGS. 1 to 3, the chip varistor T1 includes a ceramic body 3, a plurality of internal electrodes 5, and a plurality of external electrodes 7. The ceramic body 3 has, for example, a rectangular parallelepiped shape. The rectangular parallelepiped shape includes a rectangular parallelepiped shape in which corners and ridges are chamfered, or a rectangular parallelepiped shape in which corners and ridges are rounded. The plurality of internal electrodes 5 are disposed in the ceramic body 3. The plurality of external electrodes 7 are disposed on the ceramic body 3. In FIG. 1, illustration of the plurality of internal electrodes 5 is omitted.

The ceramic body 3 includes a pair of side surfaces 3a opposing each other, a pair of side surfaces 3c opposing each other, and a pair of side surfaces 3e opposing each other. Each of the side surfaces 3a, 3c, and 3e has a rectangular shape. The rectangular shape includes, for example, a shape in which each corner is chamfered or a shape in which each corner is rounded.

The pair of side surfaces 3a oppose each other in a first direction D1. The pair of side surfaces 3c oppose each other in a second direction D2. The side surfaces 3e oppose each other in a third direction D3. The first direction D1 intersects the second direction D2 and intersects the third direction D3. The second direction D2 intersects the third direction D3. The first direction D1, the second direction D2, and the third direction D3 are orthogonal to each other. The side surface 3a is orthogonal to the first direction D1. The side surface 3c is orthogonal to the second direction D2. The side surface 3e is orthogonal to the third direction D3.

The side surface 3e extends in the first direction D1 to couple the pair of side surfaces 3a. The side surface 3e extends in the second direction D2 to couple the pair of side surfaces 3c. The side surface 3a extends in the third direction D3 to couple the pair of side surfaces 3e. The side surface 3c extends in the third direction D3 to couple the pair of side surfaces 3e.

The chip varistor T1 is solder-mounted on an electronic device, for example. The electronic device includes, for example, a circuit board or an electronic component. In the chip varistor T1, one of the four side surfaces 3a and 3c opposes the electronic device. The one of the four side surfaces 3a and 3c is arranged to constitute a mounting surface. The one of the four side surfaces 3a and 3c includes the mounting surface.

The ceramic body 3 includes a multilayer structure in which a plurality of ceramic layers are laminated. The laminating direction of the plurality of ceramic layers coincides with the first direction D1. Each ceramic layer includes a sintered body exhibiting varistor characteristics. The ceramic body 3 includes, for example, a semiconductor ceramic material. In the actual ceramic body 3, the ceramic layers are integrated to such an extent that boundaries between the ceramic layers cannot be visually recognized. The ceramic body 3 includes a varistor body.

The ceramic body 3 includes ZnO (zinc oxide). A main component of the ceramic body 3 includes ZnO. The ceramic body 3 includes a metal element including, for example, Co, a rare earth metal element (for example, Pr), a group IIIb element (B, Al, Ga, In), Si, Cr, Mo, an alkali metal element (K, Rb, Cs), and an alkaline earth metal element (Mg, Ca, Sr, Ba). The metal element is an accessory component. The accessory component may include an oxide of the metal simple substance. The accessory components of the ceramic body 3 include Co, Pr, Cr, Ca, K, and Al.

When the total content of all the materials constituting the ceramic body 3 is 100 wt %, the content of ZnO is, for example, 99.8 to 69.0 wt %. The content of the rare earth metal element in the ceramic body 3 is, for example, about 0.01 to 10 atom %. For example, the rare earth metal element includes Pr. The rare earth metal element can exhibit varistor characteristics.

The chip varistor T1 includes a covering layer 9. The covering layer 9 is disposed on an outer surface of the ceramic body 3. The covering layer 9 is disposed on the pair of side surfaces 3a, the pair of side surfaces 3c, and the pair of side surfaces 3e. The covering layer 9 covers the outer surface of the ceramic body 3. For example, the entire outer surface of the ceramic body 3 is substantially covered. The covering layer 9 is disposed, for example, directly on the outer surface of the ceramic body 3. The covering layer 9 includes a glass material. A thickness of the covering layer 9 is, for example, 0.01 to 10 μm. For example, the thickness of the covering layer 9 is 0.1 μm. The glass material includes, for example, SiO₂—Al₂O₃—LiO₂-based crystallized glass. The glass material may include amorphous glass. The chip varistor T1 may not include the covering layer 9.

The chip varistor T1 has, for example, a 0402 size in JIS indication. The 0402 size in the JIS indication corresponds to a 01005 size in EIA indication. In the chip varistor T1 having the 01005 size in EIA indication, a length of the ceramic body 3 in the first direction D1 is, for example, about 0.2 mm. A length of the ceramic body 3 in the second direction D2 is about 0.2 mm. A length of the ceramic body 3 in the third direction D3 is about 0.4 mm.

As illustrated in FIGS. 2 and 3, the chip varistor T1, for example, includes a pair of internal electrodes 5. The internal electrodes 5 oppose each other in the first direction D1. The pair of internal electrodes 5 are disposed in the ceramic body 3. Each of the internal electrodes 5 opposes a corresponding side surface 3a. Each of the internal electrodes 5 is connected to a corresponding external electrode 7. Each of the internal electrodes 5 is electrically and physically connected to the corresponding external electrode 7.

When viewed in the first direction D1, the pair of internal electrodes 5 include a region overlapping each other. The pair of internal electrodes 5 are separated from each other in the first direction D1. Each of the internal electrodes 5 includes a pair of surfaces opposing each other in the first direction D1. One of the pair of surfaces included in one internal electrode 5 opposes the corresponding side surface 3a. Another of the pair of surfaces included in the one internal electrode 5 opposes another internal electrode 5.

Each of the pair of internal electrodes 5 includes an end exposed to a corresponding side surface 3e. The end included in each of the pair of internal electrodes 5 protrudes from the corresponding side surface 3e and penetrates the covering layer 9. The end included in each of the pair of internal electrodes 5 includes a portion exposed to the covering layer 9. The pair of internal electrodes 5 are positioned in the ceramic body 3 except for the end exposed to the covering layer 9.

Each of the pair of internal electrodes 5 has, for example, a rectangular shape when viewed in the first direction D1. In each of the pair of internal electrodes 5, for example, a length in the third direction D3 is larger than a length in the second direction D2. Sizes of the pair of internal electrodes 5 are substantially the same. A thickness of the internal electrode 5 in the first direction D1 is, for example, 0.5 to 4.0 μm. A length of the internal electrode 5 in the second direction D2 is, for example, 100 μm. A length of the internal electrode 5 in the third direction D3 is, for example, 300 μm.

Each of the pair of internal electrodes 5 includes a noble metal or a noble metal alloy. The noble metal includes, for example, Ag, Pd, Au, or Pt. The noble metal alloy includes, for example, an Ag—Pd alloy. The internal electrode 5 may include a base metal or a base metal alloy. The base metal includes, for example, Cu or Ni. The internal electrode 5 includes an internal conductor disposed in the ceramic body 3, and includes a conductive material usually used as an internal electrode of a multilayer electronic component. The conductive material includes, for example, a base metal. The conductive material includes, for example, Ni or Cu. The internal electrode 5 includes a sintered body of a conductive paste including the above-described conductive material.

As illustrated in FIGS. 1 to 3, the chip varistor T1, for example, a pair of external electrodes 7. The pair of external electrodes 7 are disposed on the ceramic body 3. The pair of external electrodes 7 are disposed on the outer surface of the ceramic body 3. The pair of external electrodes 7 are disposed, for example, at both ends of the ceramic body 3 in the third direction D3. The pair of external electrodes 7 oppose each other in the third direction D3 with the ceramic body 3 interposed therebetween. The pair of external electrodes 7 are separated from each other in the third direction D3.

The pair of external electrodes 7 are disposed on the covering layer 9, for example. Each of the pair of external electrodes 7 is physically and electrically connected to a corresponding internal electrode 5 at the portions of the pair of internal electrodes 5 exposed to the covering layer 9. The covering layer 9 includes a portion covered with the pair of external electrodes 7 and a portion exposed to the pair of external electrodes 7.

Each of the pair of external electrodes 7 is disposed on a corresponding one of the pair of side surfaces 3e. The pair of external electrodes 7 are disposed, for example, on the side surface 3e and a part of each of the four side surfaces 3a and 3c. The part of each of the side surfaces 3a and 3c includes a partial region near the side surface 3e in each of the side surfaces 3a and 3c. Each of the pair of external electrodes 7, for example, covers the entire corresponding side surface 3e. The pair of external electrodes 7 cover corners formed by the side surface 3e and the side surfaces 3a and 3c and ridges coupled by the corners.

The external electrode 7 includes a sintered metal layer 7a. The sintered metal layer 7a is formed through applying a conductive paste onto the outer surface of the ceramic body 3 and sintering the paste. The conductive paste includes a metal powder, a glass component, an organic binder, and an organic solvent. The sintered metal layer 7a is formed through sintering a metal component included in the conductive paste. For example, the metal component includes a metal powder. The sintered metal layer 7a includes a layer obtained through sintering the metal powder included in the conductive paste. The metal powder included in the conductive paste includes a metal powder of a noble metal and a metal powder of a base metal. The noble metal includes Ag. The noble metal may include Au, Pt, or Pd. The base metal may include Cu or Ni. For example, the sintered metal layer 7a includes Ag and Cu.

The external electrode 7 includes at least one plating layer on the sintered metal layer 7a. The external electrode 7 includes, for example, two plating layers 7b and 7c on the sintered metal layer 7a. The sintered metal layer 7a is an underlayer for forming the plating layers 7b and 7c. The plating layer 7b is positioned between the sintered metal layer 7a and the plating layer 7c. The plating layer 7b includes, for example, a Ni plating layer. The plating layer 7b may include a Sn plating layer, a Cu plating layer, or an Au plating layer instead of the Ni plating layer. The plating layer 7c includes a solder plating layer. The solder plating layer includes a Sn plating layer, a Sn—Ag alloy plating layer, a Sn—Bi alloy plating layer, or a Sn—Cu alloy plating layer. These plating layers are formed through a plating. The plating includes, for example, an electrolytic plating. The external electrode 7 may include three plating layers on the sintered metal layer 7a. A thickness of the external electrode 7 is, for example, 10 to 30 μm.

FIG. 4 is a diagram illustrating a configuration of a cross section of the sintered metal layer 7a. FIG. 5 is an enlarged diagram of a part of the configuration of the cross section of the sintered metal layer 7a. FIGS. 4 and 5 are diagrams illustrating the configuration of the cross section of the sintered metal layer 7a when taken along a plane parallel to the side surface 3c.

The sintered metal layer 7a includes a region R1, a region R2 in contact with the region R1, and a region R3 in contact with the region R2. The region R1 includes a plurality of crystal grains CG1. Each of the plurality of crystal grains CG1 includes a first metal. The region R2 includes a plurality of crystal grains CG2. Each of the plurality of crystal grains CG2 includes a second metal. The second metal is different from the first metal. For example, the first metal includes Ag, and the second metal includes Cu. The crystal grains CG1 include Ag particles, and the crystal grains CG2 include Cu particles. The region R3 includes glass G1. The glass G1 includes, for example, SiO₂ or B₂O₃.

For example, when the region R1 includes a first region, the region R2 includes a second region, and the region R3 includes a third region. For example, when the crystal grain CG1 includes a first crystal grain, the crystal grain CG2 includes a second crystal grain.

In the cross section of the sintered metal layer 7a, the plurality of crystal grains CG1 are positioned in contact with each other. Of the plurality of crystal grains, adjacent crystal grains CG1 are sintered to each other. Each of the plurality of crystal grains CG2 includes a particle positioned between the plurality of crystal grains CG1. The plurality of crystal grains CG2 include, for example, a plurality of particles positioned between the plurality of crystal grains CG1 and being in contact with each other. Each of the plurality of crystal grains CG2 include a particle positioned along a grain boundary formed by the plurality of crystal grains CG1. The plurality of crystal grains CG2 may include a plurality of particles positioned along the grain boundary formed by the plurality of crystal grains CG1. Each of the plurality of crystal grains CG2 may include a particle independently positioned between grain boundaries formed by the plurality of crystal grains CG1. Each of the plurality of crystal grains CG1 and each of the plurality of crystal grains CG2 are, for example, in direct contact with each other.

The sintered metal layer 7a includes a grain boundary formed by the plurality of crystal grains CG1 and a grain boundary formed by the plurality of crystal grains CG2 that appear in the cross section of the sintered metal layer 7a. A region where the alloy does not exist includes a place where the crystal grain CG1 and the crystal grain CG2 are in direct contact with each other. In the region where the alloy does not exist, the first metal and the second metal are not alloyed.

The second metal has an ionization tendency larger than an ionization tendency of the first metal. Therefore, Cu of the second metal further tends to react with oxygen than Ag of the first metal. In the sintered metal layer 7a, Cu further tends to exist as an oxide than Ag. The oxide of Cu includes, for example, CuO.

In the cross section of the sintered metal layer 7a, the area of the region R1 is larger than the area of the region R2. In the cross section, the area ratio of the region R1 to the region R2 is larger than 1. The area of the region R1 is the sum of the plurality of crystal grains CG1 exposed to the cross section of the sintered metal layer 7a. The area of the region R2 is the sum of the plurality of crystal grains CG2 exposed to the cross section of the sintered metal layer 7a. In the sintered metal layer 7a, the existence ratio of the region R1 and the region R2 is larger than 1, the existence ratio being expressed by the area ratio of the region R1 to the region R2.

The area ratio of the regions R1 and R2 is obtained, for example, as follows.

A cross-sectional photograph of the ceramic body 3 at a position including the region R1 and the region R2 is obtained. The cross-sectional photograph includes, for example, a photograph of a cross section of the sintered metal layer 7a taken along a plane orthogonal to a thickness direction of the sintered metal layer 7a. The cross section is, for example, parallel to the side surface 3c. The cross-sectional photograph may include, for example, a photograph of a cross section of the sintered metal layer 7a taken along a plane parallel to the side surface 3a or the side surface 3e. The cross-sectional photograph includes, for example, a scanning electron microscope (SEM) photograph. The SEM photograph includes, for example, a composition image photograph.

To calculate the areas of the regions R1 and R2, image processing of the obtained cross-sectional photograph is performed using software. Based on the result of the image processing, the boundaries of the crystal grains CG1 and the crystal grains CG2 are determined, and the areas of the crystal grains CG1 and CG2 are calculated. The area of the region R1 is calculated as a product of the number of crystal grains CG1 included in the region R1 and the area of the crystal grain CG1 in the obtained cross-sectional photograph. The area of the region R2 is calculated as a product of the number of crystal grains CG2 included in the region R2 and the area of the crystal grain CG2 in the obtained cross-sectional photograph.

The area ratio of the region R1 to the region R2 is obtained as a ratio of the area of the region R1 calculated as described above to the area of the region R2 calculated as described above.

The grain sizes of the crystal grains CG1 and CG2 are calculated, for example, as a grain size converted into an equivalent circle diameter from the areas of the crystal grains CG1 and CG2 calculated above. For example, the grain sizes of all the crystal grains CG1 included in the region R1 may be calculated, and the grain sizes of all the crystal grains CG2 included in the region R2 may be calculated. The grain sizes of an arbitrary number of crystal grains CG1 of the crystal grains CG1 included in the region R1 may be calculated, and the grain sizes of an arbitrary number of crystal grains CG2 of the crystal grains CG2 included in the region R2 may be calculated. The arbitrary number is, for example, 50.

In the cross section of the sintered metal layer 7a, the plurality of crystal grains CG1 has a grain size larger than the grain size of the plurality of crystal grains CG2. The grain size of the crystal grain CG1 is, for example, 0.4 to 3.6 μm. The grain size of the crystal grain CG2 is, for example, 0.2 to 1.4 μm. The minimum value of the grain size of the crystal grain CG1 is larger than the minimum value of the grain size of the crystal grain CG2. The maximum value of the grain size of the crystal grain CG1 is larger than the maximum value of the grain size of the crystal grain CG2.

The sintered metal layer 7a includes the glass G1. The glass G1 is included in the region R3. The region R3 is formed between the plurality of crystal grains CG1 while sintering the plurality of crystal grains CG1 together. The glass component included in the conductive paste forming the sintered metal layer 7a is softened while forming the sintered metal layer 7a, and flows into at least a part between the plurality of crystal grains CG1. The glass component flows into at least a part between the plurality of crystal grains CG1. A part between the plurality of crystal grains CG1 is filled with the glass component. The glass solidified between the plurality of crystal grains CG1 constitutes the region R3. The second metal exists around the glass G1 included in the region R3.

The sintered metal layer 7a is formed with voids V1. The voids V1 are formed while forming the sintered metal layer 7a. The voids V1 exist between the plurality of crystal grains CG1. The region R2 is exposed to the void V1. The second metal is exposed to the void V1. The voids V1 are positioned between the plurality of crystal grains CG1, and the voids V1 are not filled with the glass G1.

FIG. 6 is a diagram illustrating a configuration of a surface of the sintered metal layer 7a. FIG. 7 is an enlarged diagram of a part of the configuration of the surface of the sintered metal layer 7a. FIGS. 6 and 7 illustrate a surface 7s of the sintered metal layer 7a as viewed in the thickness direction of the sintered metal layer 7a. The thickness direction of the sintered metal layer 7a includes the third direction D3. For example, the surface 7s of the sintered metal layer 7a has a configuration similar to the configuration of the cross section of the sintered metal layer 7a exemplified in FIG. 4.

In the surface 7s of the sintered metal layer 7a, the plurality of crystal grains CG1 are positioned in contact with each other. Each of the plurality of crystal grains CG1 includes a region where the crystal grains are sintered to each other. The plurality of crystal grains CG2 include particles between the plurality of crystal grains CG1. The plurality of crystal grains CG2 include, for example, particles between the plurality of crystal grains CG1 in a state of being positioned in contact with each other. The plurality of crystal grains CG2 include particles positioned along a grain boundary formed by the plurality of crystal grains CG1. Each of the plurality of crystal grains CG1 and each of the plurality of crystal grains CG2 are, for example, in direct contact with each other.

The surface 7s of the sintered metal layer 7a includes a grain boundary formed by the plurality of crystal grains CG1 and a grain boundary formed by the plurality of crystal grains CG2. A grain boundary between the crystal grain CG1 and the crystal grain CG2 includes a region where an alloy of the first metal and the second metal does not exist. In the region where the alloy does not exist, the first metal and the second metal are not alloyed with each other at a place where the crystal grain CG1 and the crystal grain CG2 are in direct contact with each other.

In the surface 7s, the area of the region R1 is larger than the area of the region R2. In the surface, the area ratio of the region R1 to the region R2 is larger than 1. The area of the region R1 is the sum of the plurality of crystal grains CG1 exposed to the surface 7s. The area of the region R2 is the sum of the plurality of crystal grains CG2 exposed to the surface 7s. In the surface 7s, the existence ratio of the region R1 and the region R2 is larger than 1, the existence ratio being expressed by the area ratio of the region R1 to the region R2.

In the surface 7s of the sintered metal layer 7a, the area ratio of the regions R1 and R2 is obtained, for example, by a procedure similar to that in the case of the cross section of the sintered metal layer 7a.

A surface photograph of the ceramic body 3 at a position including the region R1 and the region R2 is obtained. The surface photograph includes, for example, a photograph of the surface 7s when viewed in the thickness direction of the sintered metal layer 7a. The surface 7s is, for example, parallel to the side surface 3e. The surface photograph may include a photograph obtained through photographing the surface 7s parallel to any one of the side surfaces 3a and 3c. The surface photograph includes, for example, a field emission scanning electron microscope (FE-SEM) photograph (for example, a secondary electrophotographic image). Hereinafter, the area ratio of the regions R1 and R2 is obtained in a similar manner to that in the case of the cross section of the sintered metal layer 7a.

The grain sizes of the crystal grains CG1 and CG2 are also calculated, for example, as a grain size converted into an equivalent circle diameter from the areas of the crystal grains CG1 and CG2 calculated above. In the surface 7s of the sintered metal layer 7a, the plurality of crystal grains CG1 has a grain size larger than the grain size of the plurality of crystal grains CG2. The grain size of the crystal grain CG1 is, for example, 0.4 to 3.6 μm. The grain size of the crystal grain CG2 is, for example, 0.2 to 1.4 μm. The minimum value of the grain size of the crystal grain CG1 is larger than the minimum value of the grain size of the crystal grain CG2. The maximum value of the grain size of the crystal grain CG1 is larger than the maximum value of the grain size of the crystal grain CG2.

The surface 7s of the sintered metal layer 7a includes the glass G1. The region R3 is formed between the plurality of crystal grains CG1 while sintering the plurality of crystal grains CG1 forming the surface 7s of the sintered metal layer 7a together. For example, the glass component included in the conductive paste forming the sintered metal layer 7a is softened while forming the sintered metal layer 7a, and flows into a part between the plurality of crystal grains CG1 positioned in the surface 7s. For example, a part between the plurality of crystal grains CG1 positioned in the surface 7s is filled with the glass component.

The surface 7s of the sintered metal layer 7a is formed with the voids V1. The voids V1 are formed while forming the surface 7s of the sintered metal layer 7a. The voids V1 exist between the plurality of crystal grains CG1. The region R2 is exposed to the void V1. The second metal is exposed to the void V1.

A producing method of the chip varistor T1 will be described.

For example, the ceramic body 3 in which the internal electrodes 5 are disposed is prepared. Preparing the ceramic body 3 is known in this technical field, and further detailed description will be omitted.

After preparing the ceramic body 3 in which the internal electrodes 5 are disposed, the external electrodes 7 are formed. In forming the external electrode 7, a conductive paste is applied to the side surface 3e of the ceramic body 3. For example, the conductive paste for the external electrode 7 includes Ag particles, Cu particles, a glass component, and an organic binder. In the conductive paste, the content of the Ag particles is, for example, 65 to 80 wt %. The content of the Cu particles is, for example, 1 to 4 wt %. The content of the glass component is, for example, 3 to 7 wt %. The glass component includes, for example, SiO₂ or B₂O₃. In the conductive paste, the particle size of the Ag particles is, for example, 0.04 to 9.0 μm. The particle size of the Cu particles is, for example, 0.15 to 0.7 μm.

The conductive paste is sintered in a sintering furnace to form the sintered metal layer 7a. The conductive paste is sintered through a sintering process to form the sintered metal layer 7a. The sintering process of the conductive paste includes, for example, a first temperature raising process, a first temperature keeping process, a second temperature raising process, a second temperature keeping process, and a temperature lowering process. In the first temperature keeping process after the first temperature raising process, the organic binder is removed. After the first temperature keeping process, the glass is melted in the second temperature raising process. After the glass begins to melt, sintering of Ag begins. The temperature at which the sintering of Ag begins is higher than that when the conductive paste does not include Cu. At the temperature at which the sintering of Ag begins, Cu tends not to melt and remains in a solid state. Cu has a melting point higher than the melting point of Ag. Cu reduces contact between the first metals and delays the beginning of sintering of Ag. For example, in the second temperature raising process, Cu forms an oxide.

The plurality of voids V1 are formed between a plurality of sintered pieces of Ag. Cu decreases contact between the plurality of pieces of Ag, and Cu tends to be exposed to the plurality of voids V1. For example, the softened glass flows between the plurality of pieces of Ag during the second temperature raising process.

The sintered metal layer 7a is formed through the second temperature keeping process and the temperature lowering process. The glass G1 flowing between the plurality of pieces of Ag is solidified. Subsequently, the plating layers 7b and 7c are, for example, formed on the sintered metal layer 7a through, for example, a wet plating. The wet plating includes an electrolytic plating.

Through the above processes, the chip varistor T1 is produced. For example, the ceramic body 3 may be subjected to an annealing treatment. The ceramic body 3 may not be subjected to the annealing treatment.

In the chip varistor T1, the content of the Ag particles in the sintered metal layer 7a is, for example, 88 to 94 wt %. The content of copper oxide particles is, for example, 2 to 4 wt %. The content of glass is, for example, 4 to 8 wt %. The copper oxide includes, for example, CuO.

As described above, in the chip varistor T1, the sintered metal layer 7a has an existence ratio of the first region R1 and the region R2 that is larger than 1, the existence ratio being expressed by the area ratio of the region R1 to the region R2. The plurality of crystal grains CG2 included in the region R2 tends to be in contact with the plurality of crystal grains CG1 included in the region R1 having an area ratio larger than the area ratio of the region R2. The plurality of crystal grains CG2 reduce contact between the plurality of crystal grains CG1. The glass G1 included in the region R3 contacts the region R2, and exists between the plurality of crystal grains CG1 having reduced contact with each other. The sintered metal layer 7a is further densified. Therefore, characteristic deterioration of the chip varistor T1 is reduced. The characteristics of the chip varistor T1 include, for example, electrical characteristics.

In a chip varistor, a sintered metal layer not including the second metal tends not to expose glass on the surface of the sintered metal layer. In the sintered metal layer 7a including the second metal, the glass G1 tends not to expose to the surface 7s of the sintered metal layer 7a. Glass floating on the surface 7s of the sintered metal layer 7a is reduced. In the chip varistor T1, the glass G1 between the plurality of crystal grains CG1 densified the sintered metal layer 7a.

In the chip varistor T1, the area ratio of the region R1 to the region R2 is larger than 1, in the cross section of the sintered metal layer 7a.

In the chip varistor T1, the plurality of crystal grains CG2 further tend to be in contact with the plurality of crystal grains CG1 in the cross section, and further reduce the contact between the plurality of crystal grains CG1. The glass G1 included in the region R3 contacts the region R2, and can further exist between the plurality of crystal grains CG1 having reduced contact with each other. The sintered metal layer 7a is further densified. Therefore, the characteristic deterioration of the chip varistor T1 is reliably reduced.

In the chip varistor T1, the plurality of crystal grains CG1 has the grain size larger than the grain size of the plurality of crystal grains CG2 in the cross section of the sintered metal layer.

In the chip varistor T1, the plurality of crystal grains CG2 tend to be positioned between the plurality of crystal grains CG1 in the cross section, and still further reduce the contact between the plurality of crystal grains CG1. The glass G1 included in the region R3 contacts the region R2, and can still further exist between the plurality of crystal grains CG1 having reduced contact with each other. The sintered metal layer 7a is still further densified. Therefore, the characteristic deterioration of the chip varistor T1 is further reliably reduced.

In the chip varistor T1, the area ratio of the region R1 to the region R2 is larger than 1, in the surface 7s of the sintered metal layer 7a.

In the chip varistor T1, the plurality of crystal grains CG2, in the surface 7s, further tend to be in contact with the plurality of crystal grains CG1, and further reduce the contact between the plurality of crystal grains CG1. The glass G1 included in the region R3 contacts the region R2, and can further exist between the plurality of crystal grains CG1 having reduced contact with each other. The sintered metal layer 7a is further densified. Therefore, the characteristic deterioration of the chip varistor T1 is reliably reduced.

In the chip varistor T1, the plurality of crystal grains CG1 has the grain size larger than the grain size of the plurality of crystal grains CG2 in the surface 7s of the sintered metal layer 7a.

In the chip varistor T1, the plurality of crystal grains CG2, in the surface 7s, tend to be positioned between the plurality of crystal grains CG1, and still further reduce the contact between the plurality of crystal grains CG1. The glass G1 included in the region R3 contacts the region R2, and can still further exist between the plurality of crystal grains CG1 having reduced contact with each other. The sintered metal layer 7a is still further densified. Therefore, the characteristic deterioration of the chip varistor T1 is further reliably reduced.

In the chip varistor T1, the sintered metal layer 7a is formed with the void V1 to which the region R2 is exposed.

The chip varistor T1 decreases stress acting on the sintered metal layer 7a and decreases the occurrence of cracks in the ceramic body 3. Therefore, the characteristic deterioration of the chip varistor T1 is still further reliably reduced.

In the chip varistor T1, the sintered metal layer 7a includes a grain boundary between the crystal grains CG1 and the crystal grains CG2, the grain boundary including a region that does not include an alloy of the first metal and the second metal.

In the region where the grain boundary including a region that does not include an alloy of the first metal and the second metal, the first metal and the second metal exist independently of each other. In the chip varistor T1, the plurality of crystal grains CG2 tend to be positioned between the plurality of crystal grains CG1, and still further reduce the contact between the plurality of crystal grains CG1. The glass G1 included in the region R3 contacts the region R2, and can yet still further exist between the plurality of crystal grains CG1 having reduced contact with each other. The sintered metal layer 7a is yet still further densified. Therefore, the characteristic deterioration of the chip varistor T1 is still further reliably reduced.

In the chip varistor T1, the second metal has a melting point higher than the melting point of the first metal.

In the chip varistor T1, the second metal further tends to maintain a solid state than the first metal. The plurality of crystal grains CG2 still further reduce the contact between the plurality of crystal grains CG1. The glass G1 included in the region R3 contacts the region R2, and can yet still further exist between the plurality of crystal grains CG1 having reduced contact with each other. The sintered metal layer 7a is yet still further densified. Therefore, the characteristic deterioration of the chip varistor T1 is still further reliably reduced.

In the chip varistor T1, the second metal has an ionization tendency larger than the ionization tendency of the first metal.

In the chip varistor T1, the second metal further tends to form an oxide than the first metal. The second metal is not alloyed with the first metal. The plurality of crystal grains CG2 still further reduce the contact between the plurality of crystal grains CG1. The glass G1 included in the region R3 contacts the region R2, and can yet still further exist between the plurality of crystal grains CG1 having reduced contact with each other. The sintered metal layer 7a is still further densified. Therefore, the characteristic deterioration of the chip varistor T1 is still further reliably reduced.

In the chip varistor T1, the second metal included in the region R2 tends to decrease sintering of the first metal included in the region R1. In the sintered metal layer 7a in which the sintering of the first metal is decreased, molten glass tends to flow between the plurality of crystal grains CG1. In the sintered metal layer not including the second metal, since the sintering of the first metal proceeds early, the molten glass tends not to flow between the plurality of crystal grains CG1.

In the chip varistor T1, for example, even when a plating layer is formed on the sintered metal layer 7a through a wet plating, the glass G1 decreases inflow of moisture including a plating solution into the sintered metal layer 7a. The glass G1 prevents the moisture including the plating solution from passing through the sintered metal layer 7a and reaching an interface between the sintered metal layer 7a and the ceramic body 3. The characteristic deterioration of the chip varistor T1 is still further reliably reduced.

Although the embodiment of the present disclosure has been described above, the present disclosure is not necessarily limited to the above-described embodiment, and various modifications can be made without departing from the gist thereof.

The plurality of crystal grains CG1 may not have a grain size larger than the grain size of the plurality of crystal grains CG2. In a configuration in which the plurality of crystal grains CG1 has a grain size larger than the grain size of the plurality of crystal grains CG2, the plurality of crystal grains CG2 tend to be positioned between the plurality of crystal grains CG1 as described above, and still further reduce the contact between the plurality of crystal grains CG1. The glass G1 included in the region R3 contacts the region R2, and can still further exist between the plurality of crystal grains CG1 having reduced contact with each other. The sintered metal layer 7a is still further densified. Therefore, the characteristic deterioration of the chip varistor T1 is further reliably reduced.

The grain boundary between the crystal grain CG1 and the crystal grain CG2 may not include the region where the alloy of the first metal and the second metal does not exist. In a configuration in which the grain boundary between the crystal grain CG1 and the crystal grain CG2 includes the region where the alloy of the first metal and the second metal does not exist, the plurality of crystal grains CG2 tend to be positioned between the plurality of crystal grains CG1, and still further reduce the contact between the plurality of crystal grains CG1 as described above. The glass G1 included in the region R3 contacts the region R2, and can yet still further exist between the plurality of crystal grains CG1 having reduced contact with each other. The sintered metal layer 7a is yet still further densified. Therefore, the characteristic deterioration of the chip varistor T1 is still further reliably reduced.

The second metal may not have a melting point higher than the melting point of the first metal. In a configuration in which the second metal has a melting point higher than the melting point of the first metal, the second metal further tends to maintain a solid state than the first metal as described above. The plurality of crystal grains CG2 still further reduce the contact between the plurality of crystal grains CG1. The glass G1 included in the region R3 contacts the region R2, and can yet still further exist between the plurality of crystal grains CG1 having reduced contact with each other. The sintered metal layer 7a is yet still further densified. Therefore, the characteristic deterioration of the chip varistor T1 is still further reliably reduced.

The second metal may not have an ionization tendency larger than the ionization tendency of the first metal. In a configuration in which the second metal has an ionization tendency larger than the ionization tendency of the first metal, the second metal further tends to form an oxide than the first metal as described above. The second metal is not alloyed with the first metal. The plurality of crystal grains CG2 still further reduce the contact between the plurality of crystal grains CG1. The glass G1 included in the region R3 contacts the region R2, and can yet still further exist between the plurality of crystal grains CG1 having reduced contact with each other. The sintered metal layer 7a is yet still further densified. Therefore, the characteristic deterioration of the chip varistor T1 is still further reliably reduced.

In the above-described example, the chip varistor has been described as an example of the electronic component, but an applicable electronic component is not limited to the chip varistor. Applicable electronic components are, for example, electronic components such as capacitors, inductors, piezoelectric actuators, thermistors, solid state battery components, or composite components. The applicable electronic component may include a multilayer electronic component.

What is claimed is:

1. An electronic component comprising:
a ceramic body; and
a sintered metal layer disposed on the ceramic body,
wherein the sintered metal layer includes
a first region including a plurality of first crystal grains including a first metal,
a second region in contact with the first region and including a plurality of second crystal grains including a second metal different from the first metal, and
a third region in contact with the second region and including glass, and
the sintered metal layer has an existence ratio of the first region and the second region that is larger than 1, the existence ratio being expressed by an area ratio of the first region to the second region.

2. The electronic component according to claim 1, wherein
the area ratio of the first region to the second region is larger than 1, in a cross section of the sintered metal layer.

3. The electronic component according to claim 2, wherein
the plurality of first crystal grains has a grain size larger than the grain size of the plurality of second crystal grains in the cross section.

4. The electronic component according to claim 1, wherein
the area ratio of the first region to the second region is larger than 1, in a surface of the sintered metal layer.

5. The electronic component according to claim 4, wherein
the plurality of first crystal grains has a grain size larger than a grain size of the plurality of second crystal grains in the surface.

6. The electronic component according to claim 1, wherein
the sintered metal layer is formed with a void to which the second region is exposed.

7. The electronic component according to claim 1, wherein
the sintered metal layer includes a grain boundary between the first crystal grains and the second crystal grains, the grain boundary including a region that does not include an alloy of the first metal and the second metal.

8. The electronic component according to claim 1, wherein
the second metal has a melting point higher than a melting point of the first metal.

9. The electronic component according to claim 1, wherein
the second metal has an ionization tendency larger than an ionization tendency of the first metal.

10. The electronic component according to claim 1, wherein
the ceramic body includes a semiconductor ceramic material.
